(19) United States
(12) Patent Application Publication
(10) Pub. No.: US 2025/0344685 A1
(43) Pub. Date: Nov. 13, 2025

(54) Shaped Cuff for Use with Equine Shoe

(71) Applicant: Monty L. RUETENIK, Clear Lake Shores, TX (US)

(72) Inventor: Monty L. RUETENIK, Clear Lake Shores, TX (US)

(21) Appl. No.: 19/278,507

(22) Filed: Jul. 23, 2025

Related U.S. Application Data
(63) Continuation-in-part of application No. 18/087,606, filed on Dec. 22, 2022.
(60) Provisional application No. 63/402,565, filed on Aug. 31, 2022.

(51) Int. Cl. A01L 3/02; A01L 7/02

(52) U.S. Cl. CPC A01L 3/02; A01L 7/02

(57) ABSTRACT

A cuff that is a semi-rigid polymer having a U-shaped base and integral wall partially circumnavigating said base. The base has screw holes for attachment to a shoe and the wall has button holes for attachment to a hoof. An equine cuff-and-shoe assembly is also provided where the cuff is attached to an equine shoe, preferable a shoe that covers substantially all the underside of a hoof. Additionally, the assembly can include an orthotic and/or a pulsing bladder that fits beneath the equine hoof on the inside top of the cuff assembly when the shoe/cuff assembly is employed. Method of use are also described.

### PRIOR RELATED APPLICATIONS

This application is a continuation-in-part of Ser. No. 18/087,606, filed Dec. 22, 2022, which claims the benefit of 63/402,565, filed Aug. 31, 2022, each of which is incorporated by reference in its entirety for all purposes.

### FEDERALLY SPONSORED RESEARCH STATEMENT

Not applicable.

### REFERENCE TO MICROFICHE APPENDIX

Not applicable.

### FIELD OF THE DISCLOSURE

This invention relates to equine shoes. More specifically, it relates to an equine shaped cuff that can be attached to a separate equine shoe, preferably a shoe that covers substantially all the underside of a hoof, the cuff being designed to hold the shoe in place on an equine hoof. Additionally, the assembly of these two components can include an orthotic and/or a pulsing bladder that fits beneath the equine hoof on the inside of the cuff assembly when the shoe/cuff assembly is employed.

### BACKGROUND

Solid equine shoes are usually attached to an equine's hooves by nailing, gluing or wrapping with casting tape. However, each of these methods make it difficult to remove the shoe. In addition, nailing damages the hoof, while direct gluing makes it difficult to change the shoe when the hoof grows or otherwise needs changing. Moreover, these traditional attachment means are often inadequate to restrain the forward and/or lateral forces on the shoe when the equine stops or turns. Thus, the shoe is easily dislodged.

There have been fabric cuffs proposed and in commercial use that allow the shoe to be attached by gluing a fabric attached to the shoe to the sides and/or top of the hoof. These overcome some of the problems outlined above but are not entirely satisfactory. One difficulty is that fabric is often not strong enough to withstand normal horse motion. Further, since the cuff is fabric, it is difficult to remove as it is too flexible to be merely pried off.

Another difficulty is that the shoe and cuff are often sold as a unit, which means that cuffs have to be provided in every shoe size, of which there are a great many. This also presents a farrier with significant inventory burden to have metal shoes, polymeric shoes and cuffed shoes or boots available, each in the full range of sizes. Where a cuff is sold separate from the shoe, its attachment means to the shoe is often weak, or it necessitates a thicker shoe to provide thickness for side attachment means.

Thus, what is needed in the art is a substantially less flexible and/or stronger cuff that can be permanently or removably attached to the top side of a shoe, thus allowing a smaller range of cuff sizes to be sold to meet a great many shoe sizes. The cuff needs to be strong, somewhat flexible, but rigid enough to be pried off. It should be easily attached to the hoof and ideally would also accommodate various orthotics to cushion or pulsate the frog. An ideal cuff will be easily sized to fit individual equine hooves, but be flexible enough to fit 2 or more shoes sizes, thus, reducing the inventory needed by the farrier. Inventory can be further reduced if the cuff is sold separately from the shoe, as the shoe will have many other uses where a cuff is not required, plus the cuff can be used with differing shoe types. The present invention meets one or more of these needs.

### SUMMARY OF THE INVENTION

This invention relates to an equine shoe cuff that can be attached to a separate equine shoe, preferable a shoe that covers substantially all the underside of a hoof, the cuff being designed to hold the shoe in place on an equine hoof. The cuff has a base resembling an ordinary U-shaped metal horseshoe with an integral raised section on the front that is sloped from the front center to about the midsection (laterally) of the base.

The cuff will preferably have circular openings (holes) in the base to allow the cuff structure to be attached by screws or nails to the topside of a shoe, preferably a dual density polymer shoe, but other shoe types may be used. There may also be larger holes in the cuff wall to allow adhesive to be injected therethrough to secure the cuff structure to an equine hoof. Slits in the front wall are also preferred as allowing greater flexibility in sizing and easier placement of the hoof into the cuff.

Additionally, the invention may include cuff-and-shoe assemblies that also comprise an orthotic and/or a pulsing bladder that fits under the equine hoof on top of the shoe when attached to an equine hoof. Since the shoe, cuff and various orthotics are all separate elements, the farrier has less inventory to maintain and travel with, significantly reducing the cost and storage burden. Methods of using the cuff and its assembly and methods of applying same to an equine hoof are also provided.

### BRIEF DESCRIPTION OF DRAWINGS

The accompanying drawings, which are incorporated into and constitute a part of this specification, illustrate one or more embodiments of the present invention and, together with the detailed description, serve by way of illustration and not by limitation to explain the principles and implementations of the invention.

FIG. 1 is an illustration of the top side of an integral polymeric cuff of an embodiment of the invention with base 10 and wall 12.

FIG. 2 is an illustration of the bottom side of the cuff of FIG. 1, wherein a small amount of wall 12 is visible.

FIG. 3 is a rear view of the cuff of FIG. 1.

FIG. 4 is a front view of a polymeric cuff of another embodiment of the invention. This cuff has slits m/for greater sizing and fitting flexibility.

FIG. 5 is a perspective view of the cuff of FIG. 4.

FIG. 6 is an illustration of the top side of an elastomeric orthotic pad of an embodiment of the invention.

FIG. 7 is the bottom side of the pad of FIG. 6.

FIG. 8 is a perspective view of the pad of FIG. 6.

FIG. 9 is another perspective view of the pad of FIG. 6.

FIG. 10 is an illustration of the bottom side of a dual density polymer equine shoe of an embodiment of the invention.

FIG. 11 is a side perspective view of the shoe of FIG. 10.

FIG. 12 is an overhead view of an assembly with a shoe, cuff and orthotic of an embodiment of the invention.

FIG. 13 is a rear perspective view of the assembly of FIG. 12.

FIG. 14 is a side perspective view of the assembly of FIG. 12.

FIG. 15 is a front perspective view of the assembly of FIG. 12.

FIG. 16 is an overhead view of an assembly with a shoe and cuff and lacking any orthotic.

FIG. 17 is a side perspective view of the assembly of FIG. 16.

FIG. 18 is an overhead perspective view of an assembly with a shoe and split cuff, and lacking orthotics.

### DETAILED DESCRIPTION OF THE INVENTION

This invention is an equine shoe cuff and a shoe-and-cuff assembly that comprises a cuff and a horse shoe attached together, and methods relating to same. The shoe preferably covers the entire hoof bottom, thus providing a space to hold an orthotic beneath the hoof and inside the cutout of the cuff on top of the shoe. In particularly preferably embodiments, the shoe is the dual density polymer shoe SOFTRIDER™ available from SOFT RIDE BOOTS™ (TX). Optionally the assembly also includes an elastomeric orthotic pad disposed in the cuff structure resting on top side of the polymer shoe and/or a bladder (for pulsing the frog) that may be disposed above or below the orthotic or simply placed in the cuff-and-shoe assembly without an orthotic.

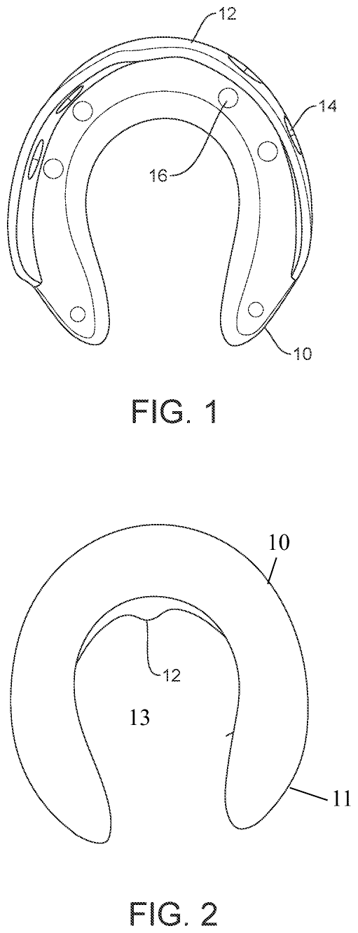

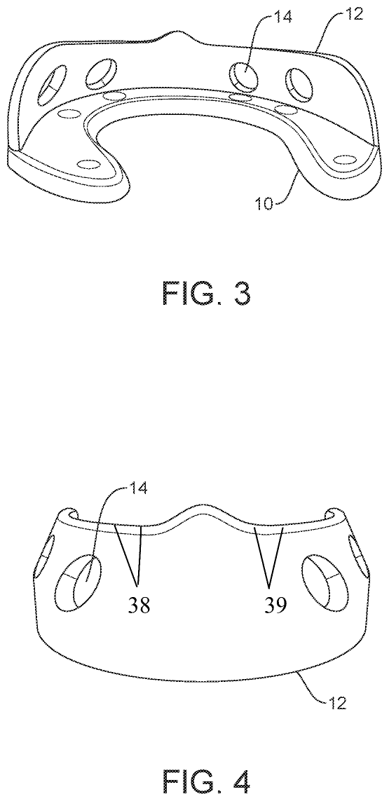

The Cuff—The cuff in various embodiments of this invention is illustrated in FIG. 1-5. The cuff itself is made of a relatively stiff polymer, preferably polyurethane. The cuffs are thus semi-rigid allowing them to be pried free of the hoof on removal, yet flexible enough to be compressed or expanded laterally to fit the hoof as well as to various sized dual density polymer shoes. Carbon fiber may also be incorporated in the resin to add strength. Durometer is in the range of 45-100 Shore D, preferably about 60-90 or about 70 or about 80 Shore D (measurements are typically +/−5 points). Durometer may vary with the number of slits as well as thickness of the cuff, the goal being to allow sufficient flex for fitting, but sufficient stiffness to allow it to be pried off after use.

As illustrated, the cuff has a base 10 that is shaped like an ordinary U-shaped metal horseshoe, having two legs 11 separated at the rear and a cutout 13 therebetween. In other words, the base 10 comprises a circular or semicircular band that forms an oval or circular shape, but that does not meet at the rear (thus forming legs 11) and is arranged to have open space (cutout 13) between the side legs 11. The cuff base is thus shaped to approximate the underside of an equine hoof and also to fit on the top side of a separate shoe, preferably a dual density polymer shoe that covers the entire hoof underside. Although the cuff can be used with traditional U-shaped horseshoes as well, the full base shoe provides a place for orthotics, pads, medicaments, and the like, and is thus preferred.

Base 10 also has a shaped raised front section or wall 12 (preferably integral with the base), wherein wall 12 partially circumnavigates base 10. The raised front wall is tapered towards the rear of the base to about half to three quarters height near, but not at the rear of the base. The horse's heels are thus never impeded by the wall 12, since the wall never reaches the back of the hoof.

The cuff may have one to four holes 14 (openings) in the front wall 12. In general, smaller cuff embodiments will have four wall holes 14 and larger cuff will have five to six holes 14. The holes, when present, will be of about ½ to 1 inch in diameter.

The base 10 also has smaller holes 16, which enable a screw gun or other driver to engage mechanical fasteners to attach the separate cuff to the shoe. The base or screw holes 16 will range from 4-8 (6 shown).

The wall holes 14 can serve to create “button keys” to provide a lock in place feature. Adhesive is applied via the holes 14, and attaches firmly to the hoof wall (normal farrier industry adhesives such as VETTECC SUPERFAST® by ROYAL KERCKHAERT HORSESHOE FACTORY® (Nederland)) creating a series of buttons the same diameter as the holes on the hoof wall and protruding through the holes. The interior of the cuff has a smooth finish so that the adhesive does not adhere to the cuff as well as the more porous hoof wall (Ra 1.6-0.05 μm or 0.8-0.2 or about 0.4 μm), a feature easily achieved with injection molding or polishing. This allows easier removal by prying the cuff away from the wall, yet the buttons ensure a secure connection that is not easily disrupted in the field.

To unlock the cuff from the hoof, the buttons are released out of the cuff holes. Small wedges can be used to pry the cuff away from the hoof, and one can push on the buttons as needed to force them back through the cuff holes. Thus, in some embodiments, the button keys remain on hoof wall, which enables the device to simply slip back on after hoof medication or other treatment. When the hoof grows out for the next trimming cycle, one can simply grind or rasp off the buttons off the hoof wall while doing a normal hoof trim.

In some embodiments, it is desirable to infuse the polymer of the cuff with carbon fibers. The carbon fiber stiffens up the polymer enabling the cuff to better hold the desired shape once attached to the dual density polymer shoe by either mechanical means or adhesive (or a combination thereof).

The front of the cuff on the center line may have a raised center alignment marker, helping the user to get proper alignment of the shoe mechanics in alignment with the distal limb visually as well as by feel.

FIG. 4 shows a variation of the cuff wall 12 with slits 38, 39 in the front wall 12 of the cuff. These slits allow the front of the cuff to be more flexible to make fitting tighter and more secure. The slits 38, 39 allow the cuff to fit a wider range of hoof and shoe sizes as they allow compression of the walls to fit a smaller or more flared hoof, and expansion to fit a wider hoof or more upright hoof. These slits are especially helpful where the front of the hoof is not quite the same shape as the cuff opening and thus allows easier entry and ultimately a better fit. The preferred slits are V shaped but simple straight slits may also be suitable, as are any other shape. We have shown two slits, which generally suffices, but more or less can be used depending on the stiffness of the polymer.

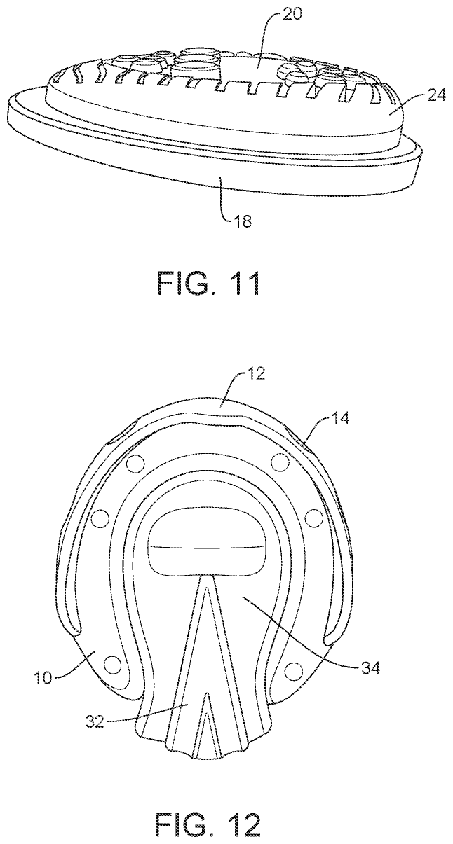

The Shoes—FIG. 10-11 illustrate embodiments of a dual density polymer (two component) equine shoe of an embodiment of the invention. Suitable polymer equine shoes for this assembly are dual density polymer (different densities of a top section and a bottom section) shoes as described in FIG. 1A, through 3A of U.S. Ser. No. 10/584,304. Also useful are the shoes described in D897052. These shoes are described as a solid, dual density, hoof shaped shoe structure designed to substantially cover the entire underside of a hoof.

In FIG. 10-11, element 18 is a layer of hard polymer that forms the top side of the shoe when in use. It is generally flat, but may be slightly convex on its upper surface to allow space for orthotics and/or the frog. Component 24 is a sloped softer bottommost component of the shoe and 20 shows one type of patterning for this component that increases traction.

The preferred shoe is sloped on its underside (see the curvature in FIG. 11) to allow the hoof to roll forward, or to the side, without unnecessary bending, thus allowing an equine to find a comfortable natural position to relieve stress on a sore, injured or diseased hoof. The structure is preferably a dual density construction with a relatively thin hard section 18 on the top, providing strength for the shoe as well as a tough attachment surface, and a thicker softer sole section 24 below providing cushioning and comfort. The patterning 20 provides traction. The harder section attaches to the hoof, preferably by adhesive, and acts to stabilize the softer lower sole section. Copper or other solid medical components may be bonded into the top side (side in contact with the hoof when in use), providing antibacterial effects.

These dual density polymer (two component) shoes place the load on the center of the hoof rather than the outside wall, allowing the wall, especially a laminitic wall, to recover. It's dual density construction helps increase blood flow to the hoof, reduces strain and pressure on the coffin bone and navicular region, and isolates the concussive force of impact with the ground on the horse's skeletal system, all while providing improved multi-directional traction. This makes them great for aging horses with issues like laminitis, navicular syndrome and ringbone, and they're also perfect for long-term use on all performance horses.

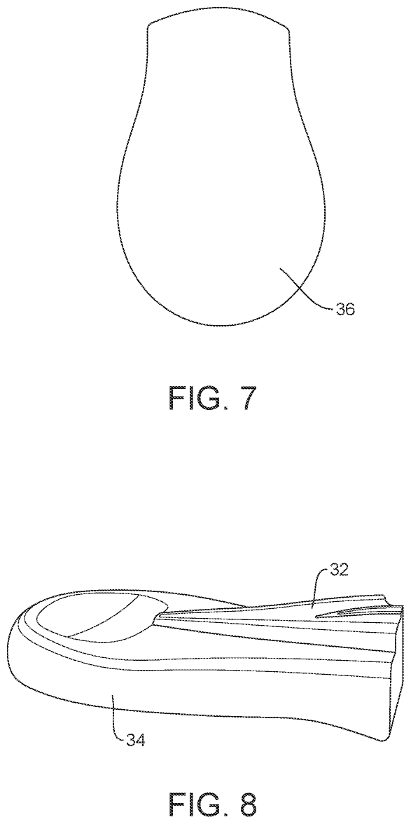

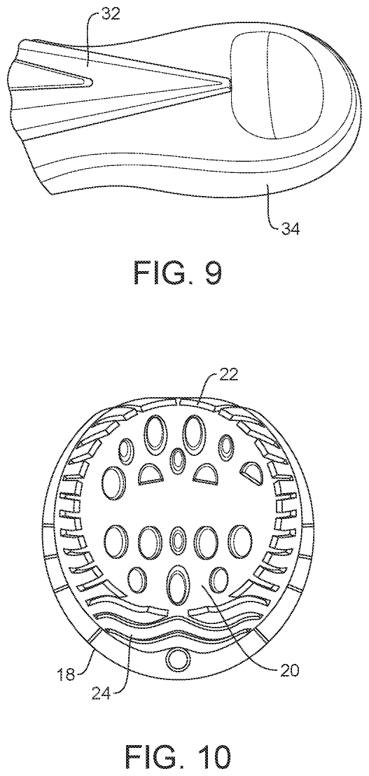

The Orthotic Pad—While there may be used any form of cushioning pad in the cuff/shoe assembly, it is sometimes desirable to use an elastomeric orthotic pad. A suitable orthotic pad is illustrated in FIG. 6-9. Elastomeric orthotic 34 is seen in FIG. 6 and FIG. 8, as well as an optional frog support 32 on the orthotic 34. The underside 36 of orthotic 34 is seen in FIG. 7. The pad 34 is preferably shaped to fit in the opening or cutout 13 of the base 10 of the cuff, resting on the top of a now cuff-attached dual density polymer shoe. The composition of the pad is preferably the same as those described in U.S. Pat. No. 9,770,018. Suitable orthotic pads are also described in U.S. Pat. Nos. 7,178,321, 7,445,051, D565256, and U.S. Pat. No. 8,220,231.

The deep gel composition of these described orthotics reaches into the crevices of a horse's foot and massages the frog, helping the natural pumping motion that circulates blood as a horse shifts it weight on its feet. These deep gel orthotics replicate the loading and unloading that occurs in nature by pumping the horse's hoof, even when its wearing shoes and standing on hard ground that doesn't conform to his hooves. The volume of the gel, paired with the shoe creates a gel platform that enables the horse to find its most comfortable hoof angle—similar to humans shifting their feet side to side to find comfort when standing.

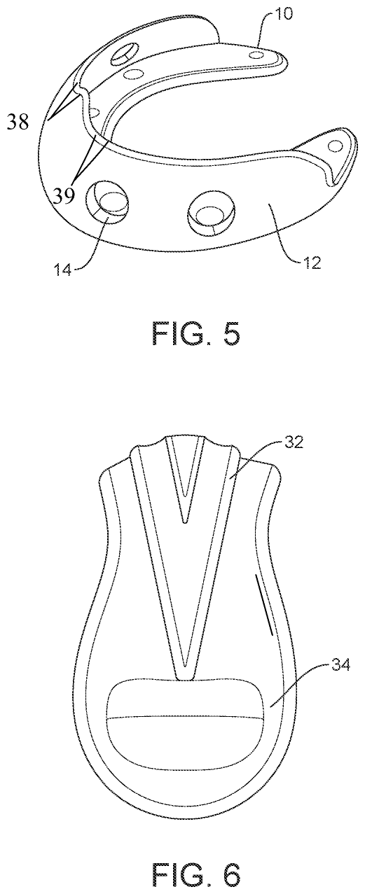

The Pulsing Bladder (Pad)—In some embodiments, there can be placed a pulsing bladder above or below the orthotic pad, or on the top side of the shoe (without the orthotic pad) in an assembly (as described below). The pad can suitably be the same as described in U.S. Pat. No. 6,651,410. As described in the patent, shoes with pulsing bladders may be placed under one or more of an equine's hooves. If placed under all four, the pulsing can be designed to simulate an equine's gait. The bladders for the embodiments will also be shaped and constructed to fit inside the cutout 13 or opening in the bottom 10 of the cuff, resting on the top of the shoe and under the frog of the hoof (e.g., between the hoof and shoe and largely inside the cutout of the U-shaped cuff base). A suitable two-port bladder with two ports is shown in FIGS. 5, 6 and 7 of U.S. Pat. No. 8,166,734, the disclosure and teachings of which are incorporated herein by reference.

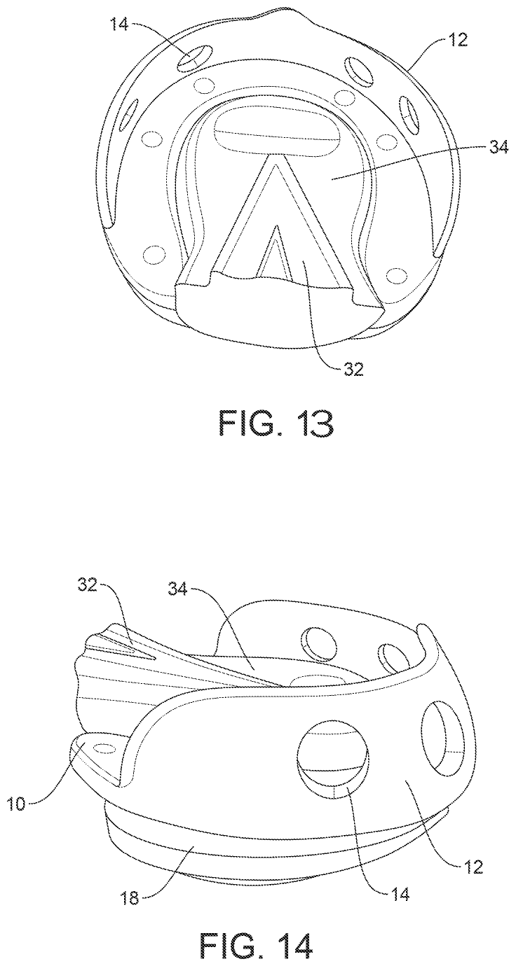

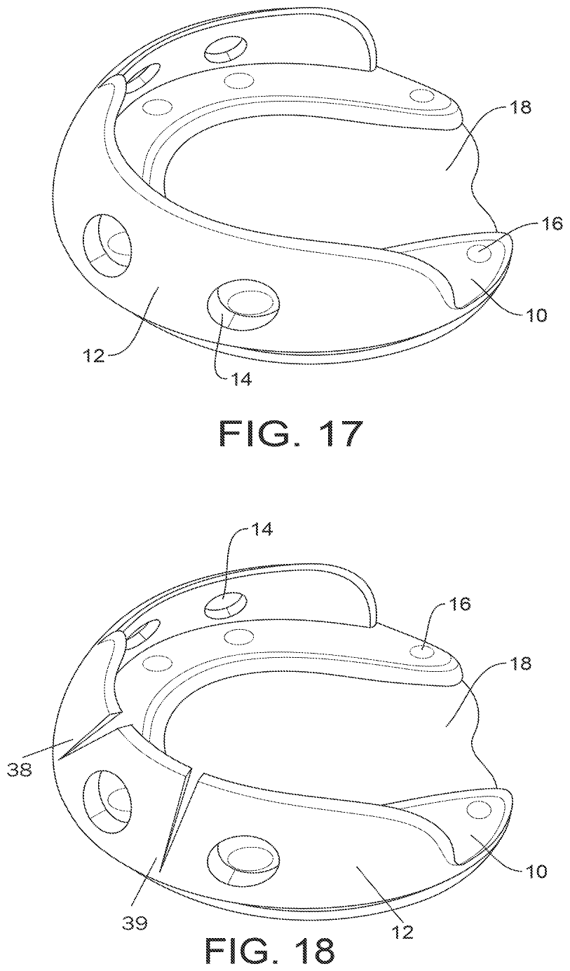

The Cuff/Shoe Assembly—FIG. 12-18 illustrate embodiments of the cuff-and-shoe assembly of the invention. Here the cuff base 10 rests atop the shoe 18 (not visible under orthotic 34, but see FIG. 16-18). The cuff base 10 may be nailed, screwed or attached by adhesive to the shoe 18, as is expedient for the user, but screws are preferred. It could also be temporarily attached by wrapping the shoe and cuff together with casting tape or the like, but this is less preferred. Items 14 are the optional holes in the cuff wall as described above and 16 (FIG. 16) are the holes in cuff base 10 through which screws or other fastener 17 mount the cuff onto the shoe.

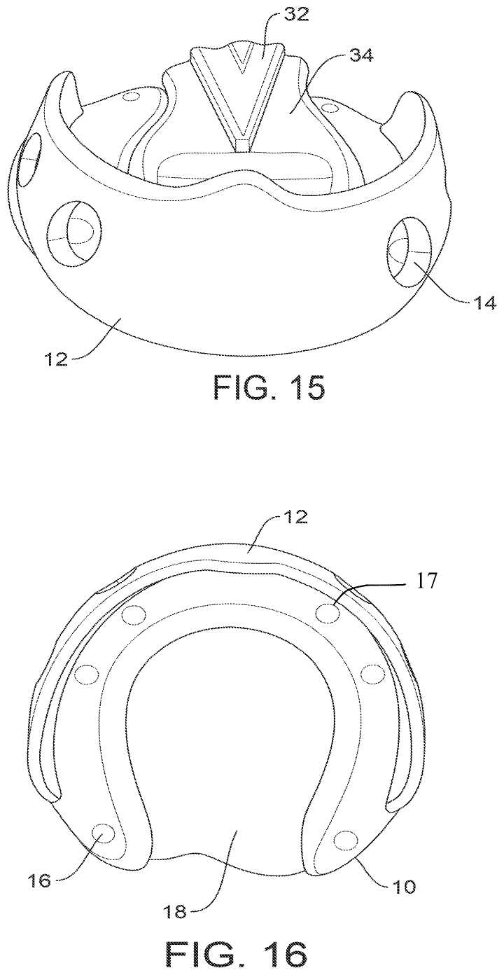

An elastomeric orthotic 34 is disposed atop the shoe between the cuff base legs 11 in cutout 13 and atop the shoe layer 18 (FIG. 15). Item 32 is the optional frog support on the orthotic. The orthotic is preferably shaped to fit into the space between the base 10 legs or bands 11, inside cutout 13.

FIG. 18 also shows the cuff wall 12 with slits 38, 39 in the front of the cuff. These slits allow the font of the cuff to be more flexible, making application easier and also allowing for adjustment of the fit.

In use the farrier will trim the hoof as needed for correction and/or treatment, and then select an appropriate shoe and cuff that will fit the hoof. The cuff is then attached to the shoe via screw holes 16, preferably with screws 17, but any fastener may be used. If needed, the farrier can warm the cuff, allowing more flexibility or the farrier may expand the cuff wall by virtue of the slits, or the farrier may choose to do both.

Glue is optionally added to one or more of the shoe top 18 or the hoof and the farrier then fits the hoof into the cuff-and-shoe assembly. The farrier may prefer to also line the inside of the cuff wall with glue before fitting or may add adhesive afterward by injecting it between the cuff and hoof. This may not be needed, however, and the farrier may only create large adhesive buttons by applying a significant amount of adhesive through the holes 14 so that some extrudes (inside and out) and then awaiting cure. If the buttons are already present, the cuff is just pushed onto the buttons, and more adhesive may be added if needed.

Where the cuff-and-shoe assembly is to be used with one or more orthotics 32, 34 those are placed into the cuff-and-shoe assembly to sit in the cutout 13 of the U-shaped base 10 before fitting onto the hoof, and the placement of glue may be limited to the edge of the shoe. Shoe glue may also be omitted in either case, as the buttons will generally suffice to secure the shoe.

To remove, a thin strong wedge is inserted between cuff and hoof, and then the cuff is slowly and carefully pried off. Since the glued surface is usually minimal and since the interior wall of the cuff is very smooth, the cuff pops off readily when the wedge is applied in our tests. If needed, the wedge can be lightly tapped with a rubber hammer. If treatment is complete, remaining adhesive may be rasped off, but if the shoe is to be replaced after treatment, the same buttons can be reused and more adhesive added as needed.

While the present invention has been illustrated by a description of various embodiments and while these embodiments have been described in considerable detail, it is not the intention of the applicant to restrict or in any way limit the scope of the appended claims to such detail.

Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept. The specification and drawings are, accordingly, to be regarded in an illustrative rather than a restrictive sense. Therefore, unless otherwise specified, the scope of the invention should be limited only by the appended claims.

The following citations are each incorporated by reference in its entirety for all purposes.
D565256 Equine boot
D616614 Equine boot
D709656 Equine boot orthotic pad
D746519 Equine boot ridged orthotic pad
D831900 D831902 Equine boot orthotic pad
D831903 D831901 Equine boot orthotic pad with frog support
D838059 Rocker attachment for equine boot
D897052 Equine shoe
D913605 Equine rocker shoe
D940967 Equine shoe
D968035 Equine shoe
U.S. Pat. No. 5,699,861 Modular shoeing system
U.S. Pat. No. 6,651,410 Comfort management system for equine
U.S. Pat. No. 7,178,321 Slip-on animal hoof boot assembly
U.S. Pat. No. 7,445,051 Equine boot
U.S. Pat. No. 8,166,734 Equine cold therapy apparatus and method
U.S. Pat. No. 8,220,231 US2009032270 Equine boot
U.S. Pat. No. 8,291,683 Equine exercise boot assembly and method
U.S. Pat. No. 9,770,018 Rocker shoe and attachment for an equine boot assembly
U.S. Ser. No. 10/206,386 US2016165871 Equine shoe
U.S. Ser. No. 10/292,378 US2017172134 Adjustable equine boot rocker attachment
U.S. Ser. No. 10/375,946 US2017290317 US2014033661 Reduced weight equine orthotic pad and method
U.S. Ser. No. 10/548,304 US2019166818 Equine Shoe
US20170099825 Equine boot assembly having an adjustable heel lift
US2019069514 Equine rocker shoe
US2021400942 Equine Shoe metal/polymer assembly
US2023309535 US2023309534 Equine shoe with concave topside

1. A cuff, said cuff consisting essentially of:
a) a U-shaped base having a space between legs of said U-shape;
b) said base having screw holes therethrough;
c) said base having an integral wall partially circumnavigating an outside edge of said base;
d) said wall tapering from a high at a front center of said base to a low at about each lateral midsection of said base;
e) a top edge of said wall having one to two slits therein;
f) said wall having four to six button holes therethrough;
g) said cuff being made of a semi-rigid polymer that is flexible enough to be compressed or expanded laterally to fit an equine hoof; and
h) said cuff configured for attaching an equine hoof to said cuff and for attaching a separate equine shoe to said cuff.

2. The cuff of claim 1, wherein said semi-rigid polymer is polyurethane.

3. The cuff of claim 1, wherein said semi-rigid polymer contains carbon fibers.

4. The cuff of claim 1, wherein said one to two slits are v-shaped slits.

5. The cuff of claim 1, wherein said cuff has a durometer of 50-100 Shore D.

6. The cuff of claim 1, wherein said cuff has a durometer of 60-80 Shore D.

7. The cuff of claim 1, wherein an inner surface of said cuff is smooth.

8. The cuff of claim 1, wherein an inner surface of said cuff is smooth with an Ra of 1-0.05 μm.

9. The cuff of claim 1, wherein an inner surface of said cuff is smooth with an Ra of 0.4-0.8 μm.

10. A cuff-and-equine shoe assembly, said assembly comprising:
a) the cuff of claim 1;
b) an equine shoe that is polymeric and shaped to substantially cover the entire underside of a hoof,
c) said base of said cuff being nailed or screwed to a top side of said equine shoe via said screw holes.

11. The assembly of claim 10, wherein said semi-rigid polymer is polyurethane.

12. The assembly of claim 10, wherein said semi-rigid polymer contains carbon fibers.

13. The assembly of claim 10, wherein said one to two slits are v-shaped slits.

14. The assembly of claim 10, further comprising an elastomeric orthotic pad positioned in said U-shaped base and resting on top of said equine shoe.

15. The assembly of claim 10, said equine shoe being sloped on an underside to allow a hoof to roll forward or to the side.

16. A cuff-and-equine shoe assembly on an equine hoof, said assembly comprising:
a) the cuff of claim 1;
b) an equine shoe that is polymeric and shaped to substantially cover the entire underside of a hoof,
c) said base of said cuff being nailed or screwed via said screw holes to a top side of said equine shoe;
d) said shoe being fitted onto an equine hoof and said cuff being locked in place on said hoof with a hoof adhesive added via said button holes.

17. A method of shoeing an equine, comprising:
a) mechanically fastening said u-shaped base of the cuff of claim 1 to a separate polymeric equine shoe via said screw holes, said shoe fitted for an equine needing shoes, such that said cuff fits atop said shoe in a cuff-and-shoe assembly;
b) fitting said cuff-and-shoe assembly to a hoof of said equine;
c) applying adhesive through said button holes of said wall of said cuff, thereby forming buttons that attach said cuff-and-shoe assembly to said hoof.

18. A method of shoeing an equine, comprising:
a) mechanically fastening said u-shaped base of the cuff of claim 1 to a separate polymeric full sole equine shoe via said screw holes, said shoe fitted for an equine needing shoes, such that said cuff fits atop said shoe in a cuff-and-shoe assembly;
b) adding an orthotic insert inside said cuff-and-shoe assembly such that said orthotic insert sits atop said equine shoe in said space;
c) fitting said cuff-and-equine shoe assembly plus orthotic insert to a hoof of said equine;
d) applying adhesive through said button holes in said wall of said cuff, thereby forming buttons keys that attach said cuff-and-shoe assembly to said hoof.

19. A method of shoeing an equine, comprising:
a) mechanically fastening said U-shaped base of the cuff of claim 1 to a separate polymeric full sole equine shoe via said screw holes, said shoe fitted for an equine needing shoes, such that said cuff fits atop said shoe in a cuff-and-shoe assembly;
b) adding an inflatable orthotic insert inside said cuff-and-shoe assembly such that said orthotic insert sits atop said equine shoe in said space;
c) fitting said cuff-and-equine shoe assembly plus orthotic insert to a hoof of said equine;
d) applying adhesive through said button holes in said wall of said cuff, thereby forming buttons keys that attach said cuff-and-shoe assembly to said hoof, and
e) connecting said inflatable orthotic insert to a pump and rhythmically inflating and deflating said orthotic insert.
